(19) United States
(12) Patent Application Publication
(10) Pub. No.: US 2011/0315291 A1
(43) Pub. Date: Dec. 29, 2011

(54) Pneumatic Object Provided with a Gas-Tight Layer Comprising a Thermoplastic Elastomer and Expanded Thermoplastic Microspheres

(75) Inventors: Vincent Abad, Chamalieres (FR); Pierre Lesage, Clermont-Ferrand (FR); Emmanuel Custodero, Chamalieres (FR)

(73) Assignees: Michelin Recherche et Technique S.A., Granges-Paccot (CH); SOCIETE DE TECHNOLOGIE MICHELIN, Clermont-Ferrand (FR)

(21) Appl. No.: 13/132,769

(22) PCT Filed: Nov. 30, 2009
(86) PCT No.: PCT/EP2009/008504

§ 371 Date: Sep. 14, 2011

(30) Foreign Application Priority Data
Dec. 3, 2008 (FR) 0858238

(51) Int. Cl. B60C 5/00; B32B 1/08

(52) U.S. Cl. 152/450; 428/35.2

(57) ABSTRACT

An inflatable article provided with an elastomer layer impermeable to the inflation gas, such as air, said layer comprising at least, as major elastomer, a thermoplastic polystirene/polyisobutylene block copolymer, such as an SIBS (stirene/isobutylene/stirene) copolymer, and expanded thermoplastic microspheres with a preferential content between 1 and 30 phr. Preferably, this copolymer comprises between 5% and 50% stirene by weight, its number-average molecular weight is between 30 000 and 500 000 g/mol and its Tg is below −20° C. Optionally, the gastight elastomer layer also contains, as plasticizer, an extender oil, especially a polybutene oil, with a preferential content between 5 and 100 phr. This gastight layer not only has excellent impermeability properties, but also a density and a hysteresis that are both reduced compared with layers based on butyl rubber. The inflatable article can be a pneumatic tire for a motor vehicle.

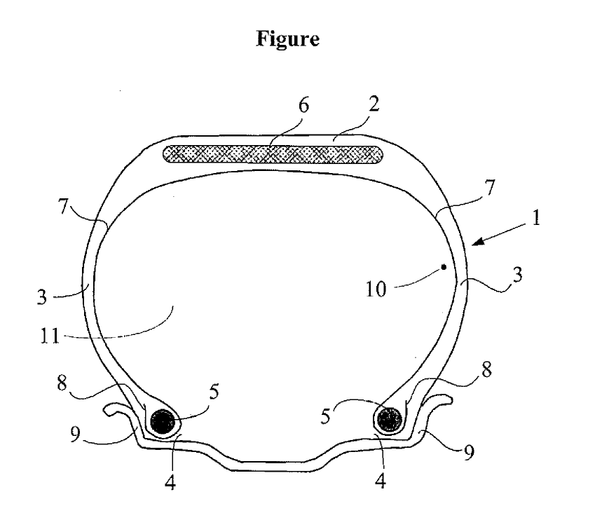

The present invention relates to “inflatable” articles, that is to say, by definition, to articles that assume their useable shape when they are inflated with air or with an equivalent inflation gas.

It relates more particularly to the gastight layers that ensure the impermeability of these inflatable articles, in particular that of pneumatic tires.

In a conventional pneumatic tire of the “tubeless” type (that is to say of the type without an inner tube), the radially internal face comprises an airtight layer (or more generally a layer that is impermeable to any inflation gas) which enables the pneumatic tire to be inflated and kept under pressure. Its impermeability properties enable it to guarantee a relatively low rate of pressure loss, making it possible to keep the tire inflated, in the normal operating state, for a sufficient time, normally several weeks or several months. It also has the role of protecting the carcass reinforcement from the diffusion of air coming from the internal space of the tire.

This role of gastight inner layer or “inner liner” is today fulfilled by compositions based on butyl rubber (isobutylene/isoprene copolymer), long renowned for their excellent impermeability properties.

However, one well-known drawback of compositions based on butyl rubber is that they have high hysteresis losses, furthermore over a wide temperature range, which drawback degrades the rolling resistance of pneumatic tires.

Reducing the hysteresis of these impermeable inner layers and therefore, in fine, the fuel consumption of motor vehicles, is a general objective which current technology comes up against.

However, the Applicants discovered, during their research, that an elastomer layer other than a butyl layer makes it possible to obtain impermeable inner layers that respond to such an objective, while affording the latter excellent impermeability properties.

Thus, according to a first object, the present invention relates to an inflatable article equipped with an elastomer layer impermeable to inflation gases, characterized in that said elastomer layer comprises at least, as major elastomer, a thermoplastic polystirene/polyisobutylene block copolymer and expanded thermoplastic microspheres.

Compared with a butyl rubber, the above thermoplastic copolymer has the major advantage, because of its thermoplastic nature, of being able to be worked as such in the molten (liquid) state and thus of offering improved processability; such a copolymer makes it possible in particular to prepare very small thicknesses of the gastight layer, and to easily integrate fillers that are difficult to disperse or relatively brittle, such as the above thermoplastic microspheres, considerably reducing the risk of degrading such fillers.

The invention particularly relates to inflatable articles made of rubber such as pneumatic tires, or inner tubes, especially inner tubes for a pneumatic tire.

The invention relates more particularly to the pneumatic tires intended to be fitted on motor vehicles of the passenger type, SUV (Sport Utility Vehicle) type, two-wheeled vehicles (especially motorcycles), aircraft, industrial vehicles such as vans, heavy vehicles (that is to say underground trains, buses, road transport vehicles such as lorries, towing vehicles, trailers, off-road vehicles, such as agricultural and civil-engineering vehicles) and other transport or handling vehicles.

The invention also relates to the use of thermoplastic polystirene/polyisobutylene block copolymer elastomer and thermally expandable thermoplastic microspheres for sealing an inflatable article from the inflation gas.

The invention and its advantages will be easily understood in light of the description and of the exemplary embodiments that follow, and also from the single FIGURE relating to these examples which schematically shows, in radial cross section, a pneumatic tire according to the invention.

### I. DETAILED DESCRIPTION OF THE INVENTION

In the present description, unless otherwise indicated, all the percentages (%) indicated are % by weight.

Moreover, any range of values denoted by the expression “between a and b” represent the field of values ranging from more than a to less than b (that is to say limits a and b excluded) whereas any range of values denoted by the expression “from a to b” means the field of values ranging from a up to b (that is say including the strict limits a and b).

### I-1. Gastight Elastomer Layer

The inflatable article according to the invention has the main feature of being equipped with a gastight layer that is formed from an elastomer composition (or “rubber”, the two terms being considered, as is known, to be synonymous) of the thermoplastic type, said layer or composition comprising at least, as major elastomer, a thermoplastic polystirene/polyisobutylene block copolymer elastomer, expanded thermoplastic microspheres and optionally an extender oil and possible other additives. All these components are described in detail below.

### I-1-A. Thermoplastic Stirene Elastomer

It will be recalled, first of all, that thermoplastic stirene (abbreviated to “TPS”) elastomers are thermoplastic elastomers which are in the form of stirene-based block copolymers. Having a structure intermediate between thermoplastic polymers and elastomers, they are composed, in a known manner, of hard polystirene blocks linked by flexible elastomer blocks, for example polybutadiene, polyisoprene or poly(ethylene/butylene) blocks. They are often triblock elastomers with two hard segments linked by a flexible segment. The hard and flexible segments may be in a linear, star or branched configuration. These TPS elastomers may also be diblock elastomers with one single hard segment linked to a soft segment. Typically, each of these segments or blocks contains at least more than 5, generally more than 10 base units (for example stirene units and isoprene units for a stirene/isoprene/stirene block copolymer).

As a reminder, the term “copolymer containing polystirene and polyisobutylene blocks” should be understood, in the present application, as meaning any thermoplastic stirene copolymer comprising at least one polystirene block (that is say one or more polystirene blocks) and at least one polyisobutylene block (that is to say one or more polyisobutylene blocks), with which other saturated or unsaturated blocks (for example polyethylene and/or polypropylene blocks) and/or other monomer units (for example unsaturated units such as diene units) may or may not be combined.

This copolymer containing polystirene and polyisobutylene blocks, also referred to as “TPS copolymer” in the present application, is in particular chosen from the group consisting of stirene/isobutylene (abbreviated to “SIB”) diblock copolymers, stirene/isobutylene/stirene (abbreviated to “SIBS”) triblock copolymers and mixtures of these, by definition completely saturated, SIB and SIBS copolymers. The invention also applies to the case in which the polyisobutylene block, in the above copolymers, can be interrupted by one or more unsaturated units, in particular one or more diene units such as isoprene units, which are optionally halogenated.

It was observed that the presence of the TPS, in particular SIB or SIBS, copolymer affords the gastight layer excellent impermeability properties while significantly reducing the hysteresis compared to conventional layers based on butyl rubber.

According to one preferred embodiment of the invention, the weight content of stirene in the TPS copolymer is between 5% and 50%. Below the minimum indicated, the thermoplastic nature of the elastomer runs the risk of being substantially reduced, whereas above the recommended maximum the elasticity of the gastight layer may be adversely affected. For these reasons, the stirene content is more preferably between 10% and 40%, in particular between 15 and 35%. The term “stirene” should be understood in the present description as meaning any monomer based on unsubstituted or substituted stirene; among substituted stirenes, mention may be made, for example, of methylstirenes (for example, α-methyl-stirene, β-methylstirene, p-methylstirene, tert-butylstirene), chlorostirenes (for example monochlorostirene, dichlorostirene).

It is preferable for the glass transition temperature (T_{g}, measured according to ASTM D3418) of the TPS copolymer to be below −20° C., in particular below −40° C. A T_{g} value above these minimum temperatures may reduce the performance of the gastight layer when used at a very low temperature; for such a use, the T_{g} of the TPS copolymer is more preferably still below −50° C.

The number-average molecular weight (denoted by Mₙ) of the TPS copolymer is preferably between 30 000 and 500 000 g/mol, more preferably between 40 000 and 400 000 g/mol. Below the minimum values indicated, the cohesion between the elastomer chains runs the risk of being adversely affected, especially due to the optional dilution thereof via an extender oil. Moreover, too high a weight may be detrimental as regards the flexibility of the gastight layer. Thus, it has been observed that a value Mₙ, lying within a range of 50 000 to 300 000 g/mol was particularly suitable, especially for use of the composition in a pneumatic tire.

The number-average molecular weight (Mₙ) of the TPS copolymer is determined in a known manner by size exclusion chromatography (SEC). The specimen is first dissolved in tetrahydrofuran with a concentration of about 1 g/l; then the solution is filtered on a filter of 0.45 μm porosity before injection. The apparatus used is a WATERS Alliance chromatograph. The elution solvent is tetrahydrofuran, the flow rate is 0.7 ml/min, the temperature of the system is 35° C. and the analysis time is 90 min. A set of four WATERS columns in series having the trade names STYRAGEL (HMW7, HMW6E and two HT6E) is used. The injected volume of the polymer specimen solution is 100 μl. The detector is a WATERS 2410 differential refractometer and its associated software for handling the chromatographic data is the WATERS MILLENNIUM system. The calculated average molecular weights are relative to a calibration curve obtained with polystirene standards.

The polydispersity index Iₚ (N.B: Iₚ=M_{w}/Mₙ, where M_{w} is the weight-average molecular weight) of the TPS copolymer is preferably less than 3, more preferably Iₚ is less than 2.

The TPS copolymer and the expanded thermoplastic microspheres may constitute by themselves the gastight elastomer layer or else they may be combined, in the elastomer composition, with other elastomers in a minor amount relative to the TPS copolymer.

If possible other elastomers are used in the composition, the TPS copolymer constitutes the major elastomer by weight. Its content is then preferably greater than 70 phr, especially in the range from 80 to 100 phr (as a reminder, “phr” means parts by weight per 100 parts of total elastomer or rubber, that is to say of all the elastomers present in the composition forming the gastight layer). Such additional elastomers, which are the minority by weight, could be for example diene elastomers such as natural rubber or a synthetic polyisoprene, a butyl rubber or thermoplastic elastomers other than stirene elastomers, within the limit of the compatibility of their microstructures.

Such complementary elastomers, in minor amounts by weight, could also be other thermoplastic stirene elastomers that may be of the unsaturated type or the saturated type (i.e., as is known, these may or may not be provided with ethylenically unsaturated groups or carbon-carbon double bonds).

As examples of unsaturated TPS elastomers, mention may for example be made of those having stirene blocks and diene blocks, in particular those chosen from the group consisting of stirene/butadiene (SB), stirene/isoprene (SI), stirene/butadiene/butylene (SBB), stirene/butadiene/isoprene (SBI), stirene/butadiene/stirene (SBS), stirene/butadiene/butylene/stirene (SBBS), stirene/isoprene/stirene (SIS) and stirene/butadiene/isoprene/stirene (SBIS) block copolymers and blends of these copolymers.

As examples of saturated TPS elastomers, mention may for example be made of those chosen from the group consisting of stirene/ethylene/butylene (SEB), stirene/ethylene/propylene (SEP), stirene/ethylene/ethylene/propylene (SEEP), stirene/ethylene/butylene/stirene (SEBS), stirene/ethylene/propylene/stirene (SEPS) and stirene/ethylene/ethylene/propylene/stirene (SEEPS) block copolymers and blends of these copolymers.

However, according to one particularly preferred embodiment, the gastight layer contains no such complementary elastomers. In other words, the TPS copolymer, in particular SIB or SIBS, described above, is the sole thermoplastic elastomer and more generally the sole elastomer present in the elastomer composition of the gastight layer.

Polystirene/polyisobutylene block copolymers are commercially available and may be processed in the conventional manner for TPS elastomers, by extrusion or moulding, for example starting from a raw material available in the form of beads or granules. For example, they are sold in respect of SIB or SIBS elastomers by KANEKA under the name “SIBSTAR” (e.g. “Sibstar 103T”, “Sibstar 102T”, “Sibstar 073T” or “Sibstar 072T” for the SIBSs; “Sibstar 042D” for the SIBs). They have for example been described, and also their synthesis, in patent documents EP 731 112, U.S. Pat. No. 4,946,899 and U.S. Pat. No. 5,260,383. They were firstly developed for biomedical applications then described in various applications specific to TPE elastomers, as varied as medical equipment, motor vehicle parts or parts for electrical goods, sheaths for electrical wires, sealing or elastic parts (see, for example, EP 1 431 343, EP 1 561 783, EP 1 566 405 and WO 2005/103146).

However, to the knowledge of the Applicants no prior art document describes the use in an inflatable article such as in particular a pneumatic tire, of an elastomer composition comprising in combination a polystirene/polyisobutylene block copolymer and expanded thermoplastic microspheres, which composition has proved, completely unexpectedly, to be able to compete with conventional compositions based on butyl rubber as gastight layer in inflatable articles.

### I-1-B. Expanded Thermoplastic Microspheres

The thermoplastic microspheres used here are well known, these being spherical resilient particles composed of a thermoplastic polymer capsule containing a liquid and/or a gas, depending on their state of expansion.

They may be used in an unexpanded form (for example as a “blowing agent”) or in an expanded form. In unexpanded form, their mean diameter generally lies in the range from 5 to 50 μm. The shells of these capsules are, for example, based on copolymers of acrylonitrile, methyl methacrylate or vinylidene chloride monomers. The liquid acting as inflation agent is typically an alkane (for example isobutane or isopentane).

Under the effect of heat, typically at temperatures of 80 to 190° C. depending on the microspheres selected, the pressure inside the sphere increases, causing the capsule to undergo irreversible expansion by plastic deformation. The final volume may thus be up to several tens of times the initial volume. These expanded microspheres may be used in various applications: they serve in particular as very low-density lightening fillers in paints, mastics, adhesives, coatings, etc. They may also improve certain usage properties of the matrices containing them; in particular, they have been described recently in compositions based on butyl rubber for pneumatic tires, for the purpose of improving the impermeability of these compositions (see especially application EP 1 967 543).

For further details about these thermoplastic microspheres, the reader may refer to the many technical documents available from their suppliers (see for example Technical Bulletin 40 from the company Expancel, entitled “Expancel® Microspheres—A Technical Presentation”, published by Akzo Nobel on 24 Jul. 2006).

As commercial examples of expandable thermoplastic microspheres that can be used in the present invention, mention may for example be made of the products provided by the company Expancel under the names “Expancel 091DU-80”, “Expancel 091DU-140” and “Expancel 092DU-120”.

Preferably, the content of expanded thermoplastic microspheres in the gastight layer is between 0.1 and 30 phr, preferably between 0.5 and 10 phr and particularly in the range from 1 to 8 phr. Below the indicated minima, the intended technical effect may be insufficient, whereas above the recommended maxima there is a risk of embrittlement and loss of endurance of the layer, without counting its increasing cost.

In the thermoplastic elastomer composition forming the gastight layer, the thermoplastic microspheres are preferably introduced in the initial state in an unexpanded form. They are then expanded, completely or partly, over the course of the various operations of compounding (with the TPS copolymer), of extrusion (of the elastomer composition forming the gastight layer) and/or of final curing or vulcanization (for example of the pneumatic tire), at the moment in fact when they reach a sufficient temperature for the expansion phase to be initiated.

### I-1-C. Extender Oil

The TPS copolymer, in particular SIB or SIBS copolymer, and the expanded thermoplastic microspheres described above are sufficient by themselves for the function of impermeability to gases with respect to the inflatable articles in which they are used to be fulfilled.

However, according to one particular embodiment of the invention, the gastight layer may also comprise, as a plasticizing agent, an extender oil (or plasticizing oil), the role of which is to facilitate the processing, particularly the integration into the inflatable article via a lowering of the modulus and an increase in the tackifying power of the gastight layer, albeit at the expense of a certain loss of impermeability.

Any extender oil may be used, preferably one having a weakly polar character, capable of extending or plasticizing elastomers, especially thermoplastic elastomers. At ambient temperature (23° C.), these oils, which are relatively viscous, are liquids (i.e. as a reminder, substances having the capability of eventually taking the form of their container), as opposed especially to resins which are by nature solids.

Preferably, the extender oil is chosen from the group consisting of polyolefin oils (i.e. those resulting from the polymerization of olefins, monoolefins or diolefins), paraffinic oils, naphthenic oils (of low or high viscosity), aromatic oils, mineral oils and mixtures of these oils. More preferably, the extender oil is chosen from the group consisting of polybutene oils, paraffin oils and mixes of these oils

Very particularly, polybutene oils, polyisobutylene (PIB) oils, are used, which demonstrated the best compromise of properties compared with the other oils tested, especially compared with oils of paraffinic type.

Examples of polyisobutylene oils include those sold in particular by Univar under the trade name “Dynapak Poly” (e.g. “Dynapak Poly 190”), by BASF under the trade names “Glissopal” (e.g. “Glissopal 1000”) or “Oppanol” (e.g. “Oppanol B12”), by Ineos Oligomer under the trade name “Indopol H1200”. Paraffinic oils are sold for example by Exxon under the trade name “Telura 618” or by Repsol under the trade name “Extensol 51”.

The number-average molecular weight (Mₙ) of the extender oil is preferably between 200 and 25 000 g/mol, more preferably still between 300 and 10 000 g/mol. For excessively low Mₙ, values, there is a risk of the oil migrating to the outside of the composition, whereas excessively high Mₙ values may result in this composition becoming too stiff. An Mₙ, value between 350 and 4000 g/mol, in particular between 400 and 3000 g/mol, proves to be an excellent compromise for the intended applications, in particular for use in a pneumatic tire.

The molecular weight Mₙ, of the extender oil is determined by SEC, the specimen being firstly dissolved in tetrahydrofuran with a concentration of about 1 g/l and then the solution is filtered on a filter of 0.45 μm porosity before injection. The apparatus is the WATERS Alliance chromatograph. The elution solvent is tetrahydrofuran, the flow rate is 1 ml/min, the temperature of the system is 35° C. and the analysis time is 30 min. A set of two WATERS columns with the trade name “STYRAGEL HT6E” is used. The injected volume of the polymer specimen solution is 100 μl. The detector is a WATERS 2410 differential refractometer and its associated software for handling the chromatograph data is the WATERS MILLENIUM system. The calculated average molecular weights are relative to a calibration curve obtained with polystirene standards.

A person skilled in the art will know, in the light of the description and the embodiments that follow, how to adjust the quantity of extender oil according to the particular usage conditions of the gastight elastomer layer, in particular of the inflatable article in which it is intended to be used.

If an extender oil is used, it is preferable for its content to be greater than 5 phr, more preferably between 5 and 100 phr. Below the indicated minimum, the elastomer layer or composition runs the risk of having too high a stiffness for certain applications, whereas above the recommended maximum there is a risk of the composition having insufficient cohesion and of a loss of impermeability which may be damaging depending on the application in question. For all these reasons, in particular for use of the gastight layer in a pneumatic tire, the extender oil content is preferably greater than 10 phr, especially between 10 and 90 phr, more preferably still is greater than 20 phr, especially between 20 and 80 phr.

### I-1-D. Various Additives

The airtight layer or composition described above may furthermore comprise the various additives usually present in the gastight layers known to a person skilled in the art. Mention will be made, for example, of reinforcing fillers such as carbon black or silica, non-reinforcing or inert fillers, lamellar fillers further improving the sealing (e.g. phyllosilicates such as kaolin, talc, mica, graphite, clays or modified clays (“organoclays”), plasticizers other than the aforementioned extender oils, protective agents such as antioxidants or antiozonants, UV stabilizers, colorants that can advantageously be used for colouring the composition, various processing aids or other stabilizers, or else promoters capable of promoting adhesion to the remainder of the structure of the inflatable article.

The use of lamellar fillers in the gastight layer advantageously makes it possible to further reduce the permeability coefficient (and therefore to increase the sealing) of the thermoplastic elastomer composition, without excessively increasing its modulus. This makes it possible to maintain the integratability of the gastight layer in the inflatable article. Such fillers generally take the form of plates, platelets, sheets or stacked sheets, of relatively pronounced anisotropy, the mean length of which is for example between a few μm and a few hundred μm. They may be used in variable weight contents depending on the applications, for example greater than 20 phr, especially greater than 50 phr.

Besides the elastomers described previously, the gastight composition could also comprise, always in a minority weight fraction relative to the TPS copolymer, polymers other than elastomers, such as for example thermoplastic polymers compatible with the TPS elastomers.

### 1-2. Use of the Elastomer Layer in an Inflatable Article

The gastight layer or composition described previously is a compound that is solid (at 23° C.) and elastic, which is especially characterized, thanks to its specific formulation, by a very high flexibility and very high deformability.

It can be used as an airtight layer (or a layer that is impermeable to any other inflation gas, for example nitrogen) in any type of inflatable article. As examples of such inflatable articles, mention may be made of inflatable boats, balloons or balls used for games or sports.

It is particularly suitable for use as an airtight layer in an inflatable article, whether a finished or semi-finished product, made of rubber, most particularly in a pneumatic tire for a motor vehicle such as a two-wheeled, passenger or industrial vehicle.

Such an airtight layer is preferably placed on the inner wall of the inflatable article, but it may also be completely integrated into its internal structure.

The thickness of the airtight layer is preferably greater than 0.05 mm, more preferably between 0.1 mm and 10 mm (especially between 0.1 and 1.0 mm).

It will be readily understood that, depending on the specific fields of application and on the dimensions and pressures involved, the method of implementing the invention may vary, the airtight layer then having several preferential thickness ranges.

Thus, for example, in the case of passenger vehicle tires, it may have a thickness of at least 0.3 mm, preferably between 0.5 and 2 mm. According to another example, in the case of heavy or agricultural vehicle tires, the preferred thickness may be between 1 and 3 mm. According to another example, in the case of pneumatic tires for vehicles in the civil engineering field or for aircraft, the preferred thickness may be between 2 and 10 mm.

Compared with a usual airtight layer based on butyl rubber, the airtight composition described above has the advantage of exhibiting a markedly lower hysteresis, and therefore of offering the pneumatic tires a reduced rolling resistance, as is demonstrated in the following exemplary embodiments.

Furthermore, because of the presence of its expanded thermoplastic microspheres, its density is appreciably reduced compared with airtight layers based on butyl rubber. Preferably, the density of the gastight layer is less than 1 g/cm³, more preferably less than 0.9 g/cm³, and in many cases may be less than 0.8 g/cm³.

### II. EXEMPLARY EMBODIMENTS OF THE INVENTION

The gastight elastomer layer described previously can advantageously be used in the pneumatic tires of all types of vehicles, in particular passenger vehicles or industrial vehicles such as heavy vehicles.

As an example, the single appended FIGURE shows very schematically (not drawn to scale), a radial cross section of a pneumatic tire according to the invention for a passenger vehicle. This pneumatic tire 1 has a crown 2 reinforced by a crown reinforcement or belt 6, two sidewalls 3 and two beads 4, each of these beads 4 being reinforced with a bead wire 5. The crown 2 is surmounted by a tread (not shown in this schematic FIGURE). A carcass reinforcement 7 is wound around the two bead wires 5 in each bead 4, the upturn 8 of this reinforcement 7 lying for example towards the outside of the pneumatic tire 1, which here is shown fitted onto its rim 9. The carcass reinforcement 7 consists, as is known per se, of at least one ply reinforced by cords, called “radial” cords, for example textile or metal cords, i.e. these cords are arranged practically parallel to one another and extend from one bead to the other so as to form an angle of between 80° and 90° with the circumferential mid-plane (the plane perpendicular to the rotation axis of the pneumatic tire, which is located at mid-distance of the two beads 4 and passes through the middle of the crown reinforcement 6).

The inner wall of the pneumatic tire 1 comprises an airtight layer 10, for example having a thickness equal to around 1.1 mm, on the side of the internal cavity 11 of the pneumatic tire 1.

This inner layer (or “inner liner”) covers the entire inner wall of the pneumatic tire, extending from one sidewall to the other, at least as far as the rim flange when the pneumatic tire is in the fitted position. It defines the radially internal face of said pneumatic tire intended to protect the carcass reinforcement from the diffusion of air coming from the internal space 11 of the pneumatic tire. It enables the pneumatic tire to be inflated and kept under pressure. Its impermeability properties ought to enable it to guarantee a relatively low rate of pressure loss, and to make it possible to keep the pneumatic tire inflated, in the normal operating state, for a sufficient time, normally several weeks or several months.

Unlike a conventional pneumatic tire that uses a composition based on butyl rubber, the pneumatic tire according to the invention uses, as the airtight layer 10, in this example, a thermoplastic elastomer composition comprising the following components:
a sole SIBS elastomer (“Sibstar 102T” with a stirene content of about 15%, a Tg of about −65° C. and a number-average molecular weight Mₙ, of about 90 000 g/mol);
2.5 parts of expanded thermoplastic microspheres (Expancel® 091DU140) per 100 parts by weight of SIBS elastomer (i.e. 2.5 phr); and
65 parts of PIB oil (“Dynapak Poly 190” with a molecular weight Mₙ, of around 1000 g/mol per 100 parts by weight of SIBS elastomer (i.e. 65 phr).

The layer 10 was prepared as follows. The mixing of the three constituents (SIBS, thermoplastic microspheres and PIB) was carried out conventionally, using a twin-screw extruder (L/D equal to around 40), at a temperature typically above the melting temperature of the composition (around 190° C.). The extruder used comprised a feed (hopper) for the SIBS, another feed (hopper) for the thermoplastic microspheres (in unexpanded, powder form) and a pressurized liquid injection pump for the polyisobutylene extender oil; it was provided with a die that makes it possible to extrude the product to the desired dimensions.

The pneumatic tire provided with its airtight layer (10) as described above may be produced before or after vulcanization (or curing).

In the first case (i.e., before vulcanization of the pneumatic tire), the airtight layer is simply applied in a conventional manner at the desired place, so as to form the layer 10. The vulcanization is then carried out conventionally. One advantageous manufacturing variant, for a person skilled in the art of pneumatic tires, would consist for example during a first step, in laying down the airtight layer directly onto a building drum, in the form of a layer with a suitable thickness, before this is covered with the rest of the structure of the pneumatic tire, according to manufacturing techniques well known to a person skilled in the art.

In the second case (i.e. after curing of the pneumatic tire), the gastight layer is applied to the inside of the pneumatic tire cured by any appropriate means, for example by bonding, by extrusion, by spraying or else by extrusion/blow moulding a film of suitable thickness.

In the following examples, the impermeability properties were first analysed on test specimens of compositions based on butyl rubber on the one hand and on SIBS and expanded thermoplastic microspheres on the other hand (with and without PIB extender oil, as regards the second composition based on SIBS and microspheres).

For this analysis, a rigid-wall permeameter was used, placed in an oven (temperature of 60° C. in the present case), equipped with a pressure sensor (calibrated in the range of 0 to 6 bar) and connected to a tube equipped with an inflation valve. The permeameter may receive standard test specimens in disc form (for example having a diameter of 65 mm in the present case) and with a uniform thickness which may range up to 3 mm (0.5 mm in the present case). The pressure sensor is connected to a National Instruments data acquisition card (0-10 V analogue four-channel acquisition) which is connected to a computer that carries out a continuous acquisition with a frequency of 0.5 Hz (1 point every two seconds). The permeability coefficient (K) is measured from the linear regression line (average over 1000 points) giving the slope α of the pressure loss, through the test specimen tested, as a function of the time, after a stabilization of the system, that is to say after obtaining a steady state during which the pressure decreases linearly as a function of the time.

It was firstly noted that the composition comprising solely the SIBS copolymer and the expanded thermoplastic microspheres, that is to say with no extender oil or other additive, had a very low permeability coefficient, substantially equal to that of the standard composition based on butyl rubber, for the same thickness. This already constitutes a remarkable result for such a composition.

As already indicated, if a certain loss of impermeability is accepted in exchange, the addition of an extender oil advantageously makes it possible to facilitate the integration of the elastomer layer into the inflatable article, via a reduction of the modulus and an increase of the tackifying power of the latter.

Thus, by using 65 phr of extender oil, it was observed that the permeability coefficient was increased (and therefore the impermeability reduced) by around 2.3 times in the presence of a conventional oil such as a paraffinic oil, whereas this coefficient was only increased by 1.5 times in the presence of a PIB oil (“Dynapak Poly 190”), an increase that finally is not very detrimental for the use in a pneumatic tire. This is why the combination of the TPS copolymer (especially SIB or SIBS copolymer), of the expanded thermoplastic microspheres and polybutene (especially PIB) oil has proved to offer the best compromise of properties in respect of the gastight layer.

Following the above laboratory tests, pneumatic tires according to the invention, of the passenger vehicle type (dimension 195/65 R15) were manufactured; their inner wall being covered with an airtight layer (10) having a thickness of 1.1 mm (on a building drum, before manufacture of the rest of the tire), then the tires were vulcanized. Said airtight layer (10) was formed from SIBS (100 phr), expanded thermoplastic microspheres (2.5 phr) and 65 phr of PIB oil, as described above.

These pneumatic tires according to the invention were compared with control tires (Michelin “Energy 3” brand) comprising a conventional airtight layer, of the same thickness, based on butyl rubber. The rolling resistance of the pneumatic tires was measured on a flywheel, according to the ISO 8767 (1992) method.

It was observed that the pneumatic tires of the invention had a rolling resistance that was reduced very significantly, and unexpectedly for a person skilled in the art, by almost 4% relative to the control pneumatic tires.

In conclusion, the gastight layer of the inflatable article of the invention not only has excellent sealing properties but also a density and a hysteresis that are both reduced compared with layers based on butyl rubber.

The invention thus offers pneumatic tire designers the opportunity of reducing fuel consumption of motor vehicles fitted with such tires, while reducing the density of the gastight layers.

1. An inflatable article equipped with an elastomer layer impermeable to inflation gases, characterized in that said elastomer layer comprises at least, as major elastomer, a thermoplastic polystirene/polyisobutylene block copolymer and expanded thermoplastic microspheres.

2. The inflatable article according to claim 1, wherein the thermoplastic copolymer is chosen from the group consisting of stirene/isobutylene copolymers, stirene/isobutylene/stirene copolymers and mixtures of these copolymers.

3. The inflatable article according to claim 1, wherein the thermoplastic copolymer comprises between 5 and 50% by weight of stirene.

4. The inflatable article according to claim 1, wherein the glass transition temperature of the thermoplastic copolymer is less than −20° C.

5. The inflatable article according to claim 1, wherein the number-average molecular weight of the thermoplastic copolymer is between 30 000 and 500 000 g/mol.

6. The inflatable article according to claim 1, wherein the gastight layer comprises an extender oil for the thermoplastic copolymer.

7. The inflatable article according to claim 6, wherein the extender oil is chosen from the group consisting of polyolefin oils, paraffinic oils, naphthenic oils, aromatic oils, mineral oils, and mixtures of these oils.

8. The inflatable article according to claim 7, wherein the extender oil is chosen from the group consisting of polybutene oils.

9. The inflatable article according to claim 8, wherein the extender oil is a polyisobutylene oil.

10. The inflatable article according to claim 6, wherein the number-average molecular weight of the extender oil is between 200 and 25 000 g/mol.

11. The inflatable article according to claim 10, wherein the content of extender oil is greater than 5 phr.

12. The inflatable article according to claim 11, wherein the content of extender oil is between 5 and 100 phr.

13. The inflatable article according to claim 1, wherein the gastight layer comprises a platy filler.

14. The inflatable article according to claim 1, wherein the content of expanded thermoplastic microspheres is between 0.1 and 30 phr.

15. The inflatable article according to claim 14, wherein the content of expanded thermoplastic microspheres is between 0.5 and 10 phr.

16. The inflatable article according to claim 1, wherein the density of the gastight elastomer layer is less than 1.0 g/cm³.

17. The inflatable article according to claim 1, wherein the density of the gastight layer is less than 0.9 g/cm³.

18. The inflatable article according to claim 1, wherein the gastight layer has a thickness greater than 0.05 mm.

19. The inflatable article according to claim 18, wherein the gastight layer has a thickness between 0.1 and 10 mm.

20. The inflatable article according to claim 1, wherein the gastight layer is placed on the inner wall of the inflatable article.

21. The inflatable article according to claim 1, wherein said article is made of rubber.

22. The inflatable article according to claim 21, wherein said rubber article is a pneumatic tire.

23. The inflatable article according to claim 21, wherein said inflatable article is an inner tube.

24. (canceled)
